(19) United States
(12) Patent Application Publication
(10) Pub. No.: US 2026/0070436 A1
(43) Pub. Date: Mar. 12, 2026

(54) BATTERY-POWERED VEHICLE AND METHOD FOR OPERATING SUCH A BATTERY-POWERED VEHICLE

(71) Applicant: AUDI AG, lngolstadt (DE)

(72) Inventors: Sebastian KEMPER, lngolstadt (DE); Paul SEELMAIER, lngolstadt (DE)

(73) Assignee: AUDI AG, lngolstadt (DE)

(21) Appl. No.: 19/308,844

(22) Filed: Aug. 25, 2025

(30) Foreign Application Priority Data
Sep. 12, 2024 (DE) 102024126316.4

(51) Int. Cl. B60L 53/10; B60K 35/28; B60L 50/60; B60L 53/62

(52) U.S. Cl. CPC B60L 53/11; B60K 35/28; B60L 50/60; B60L 53/62; B60K 2360/169; B60L 2250/16

(57) ABSTRACT

A battery-powered vehicle with a display which, during a charging process displays a maximum charging capacity which indicates the maximum charging power with which the charging process can be carried out in the best possible case, and displays a current charging capacity which indicates the actual charging power with which the charging process is currently carried out. Due to limiting influencing factors, a deviation of the actual charging power from the maximum charging power may occur. The display displays a correlating partial charging power deviation for each of the limiting influencing factors in order to make the cause of the deviation of the actual charging power from the maximum charging power understandable to the vehicle user.

### FIELD

The invention relates to a battery-powered vehicle and to a method for operating such a vehicle.

### BACKGROUND

In such a vehicle, the charging process taking place at a charging station is shown on a vehicle display, which informs the vehicle user about the current actual charging power and the maximum possible charging power. Particularly when charging at a fast charging station, limiting factors can lead to a larger deviation between the actual charging power and the maximum possible charging power. Such limiting factors include, for example, the battery temperature, the battery state of charge, the battery health, a charging strategy implemented by the battery management system, component protection and the charging infrastructure.

During the charging process, particularly during a fast charging process, a typical vehicle display shows a maximum fast charging capacity, which indicates the maximum power with which the charging process can be carried out in the best possible case. In addition, the vehicle display shows the current fast charging capability, which indicates the actual charging power at which the charging process is taking place. In practice, the limiting factors mentioned above lead to a deviation between the actual charging power and the maximum charging power.

In the prior art, the vehicle display provides the vehicle user only very limited information about why the actual charging power deviates from the maximum charging power. In some cases, the vehicle user may therefore unjustifiably suspect that the vehicle is defective. This leads to a loss of comfort or irritation for the vehicle user during the fast charging process.

From DE 10 2021 212 689 A1 a method is known for adjusting the charging power of electric vehicles by means of a device that is interposed between the charging device and the vehicle. This device receives communication signals, adjusts the available charging current based on predefined parameters and transmits them to the vehicle. A particular focus is on grid stability and the possibility of bidirectional communication between the vehicle and the charging device.

EP 37 980 45 A1 discloses a system for regulating the maximum charging power depending on the mains supply voltage. Dynamic adjustment of the charging power is proposed to avoid power peaks and minimize grid load. It also describes the possibility of receiving control information from external devices and of adjusting the charging parameters accordingly.

EP 42 177 54 B1 discloses a method for determining the performance of electrical energy storage devices, in particular by determining the electrical resistance and impedance. The method involves an indirect measurement of resistance to evaluate the performance of the battery over time.

WO 2013 149 770 A1 describes a system for controlling the charging process of an electrical energy storage device, in particular in a vehicle. The system comprises a charge level meter and enables the visualization of the charge level on mobile devices. It also describes the possibility of optimizing charging parameters based on forecast electricity prices and displaying alternative charging options to minimize costs.

### SUMMARY

The object of the invention is to provide a battery-powered vehicle and a method for operating such a battery-powered vehicle, in which the charging process, in particular the fast charging process, can be carried out more conveniently and in particular without irritations compared to the prior art.

The invention relates to a battery-powered vehicle with a display means which displays a maximum charging capacity and a current charging capacity during a charging process, in particular a fast charging process. The maximum charging capacity indicates the maximum charging power with which the charging process can be carried out in the best possible case. In contrast, the current charging capacity indicates the actual charging power at which the charging process takes place. In practice, limiting influencing factors lead to a deviation between the actual charging power and the maximum charging power. These deviations can sometimes be up to 90%, which can cause irritation for the vehicle user during the fast charging process. According to the characterizing part of claim 1, such losses of comfort or irritations during the charging process are remedied by the following measures: The display means not only shows the maximum charging power and the actual charging power; in addition, the display means shows a partial charging power deviation correlated to each of the significantly limiting influencing factors. In this way, the vehicle user is made aware of the reason for the deviation between the actual charging power and the maximum charging power.

The main advantage of the invention is that the vehicle user can understand why the actual charging power deviates from the maximum charging power. The vehicle user can therefore take appropriate measures to minimize the influencing factors. For example, if the battery temperature is too low, the vehicle user can start a preheating mode to increase the battery temperature, thereby reducing the correlated partial charging power deviation.

According to the invention, the correlated partial charging power deviations for each of these limiting factors are transparently displayed in the display means in order to make the causes of the charging power deviations understandable to the user and to enable optimization measures. The focus of the invention is therefore on transparency and user understanding of the fast charging capability of the electrically powered vehicle.

The charging power of a battery-powered vehicle is limited in particular by the following influencing factors. These can be divided into vehicle-side influencing factors, namely battery temperature, battery state, battery health, charging strategy, in which the battery management system limits the charging power for charging strategy reasons, and component protection, as well as an external influencing factor related to the charging infrastructure. The influencing factor external to the vehicle and related to the charging infrastructure refers to the fact that the charging infrastructure does not provide the stated charging power. For example, the electrically powered vehicle can be ideally preconditioned for maximum charging power (e.g. 270 kW). In contrast, a charging station operating at 350 kW, for example, may be internally limited to 170 kW for no obvious reason. In this case, the vehicle user may need to obtain information about the situation from the energy provider.

In a technical implementation, the vehicle can have an evaluation unit for each of these influencing factors. Based on the respective influencing factor, this can determine a correlating partial charging power deviation and transmit a corresponding signal to the display device.

In order to obtain meaningful information about the vehicle-external, charging infrastructure-side influencing factor, the following measure can be implemented: The evaluation unit assigned to the charging infrastructure-side influencing factor can have the following calculation modules, namely
a calculation module that calculates a total charging power deviation of the actual charging power from the maximum charging power. Both the actual charging power and the maximum charging power are already stored or available in the battery management system.
a calculation module in which the partial charging power deviations correlating with the vehicle-side influencing factors are deducted from the total charging power deviation, from which the partial charging power deviation correlating with the charging infrastructure-side influencing factor is obtained.

Alternatively, the partial charging power deviation correlating with the charging infrastructure-side influencing factor can also be determined by subtraction, in which a charging power that can be provided by the charging infrastructure is subtracted from a vehicle-side charging power requirement.

In view of a meaningful and clear presentation in the vehicle display, the following measure is preferred: The partial charging power deviation correlating with a limiting influencing factor can only be shown in the display means if it is greater than a predefined minimum value, for example 10 kW.

Alternatively and/or additionally, the following measure is preferred with regard to a clear presentation in the display means: In the event that the sum of all correlating partial charging power deviations is smaller than a predefined minimum value, this sum is displayed in the display means as a partial charging power deviation that correlates with the charging strategy of the battery management system.

### BRIEF DESCRIPTION OF THE FIGURES

An exemplary embodiment of the invention is described below on the basis of the appended figures. In the figures:

FIG. 1 is a view illustrating the components required to implement the invention.

FIG. 2 is a view illustrating the components required to implement the invention.

FIG. 3 is a view illustrating the components required to implement the invention.

FIG. 4 is a view illustrating the components required to implement the invention.

### DETAILED DESCRIPTION

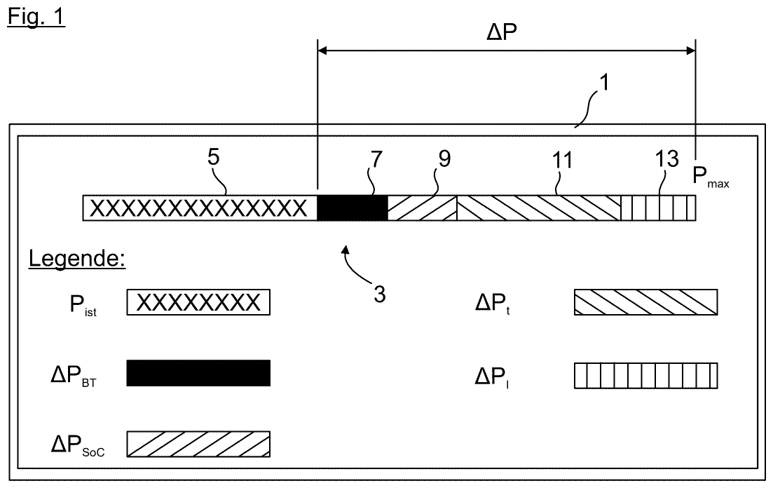

In FIG. 1, a vehicle display 1, integrated, for example, in the instrument panel of an electrically powered vehicle, is indicated as the display means to the extent that it is necessary for understanding the invention. Accordingly, the vehicle display 1 has a stacked bar chart 3 in which individual bar segments 5, 7, 9, 11, 13 merge into one another in alignment. Using the stacked bar chart 3, the vehicle user can track a fast charging process at a fast charging station.

In the fast charging process illustrated as an example in the vehicle display 1, the bar segment 5 shown on the left in the bar diagram 3 shows a current actual charging power Pᵢₛₜ. Due to limiting influencing factors, this deviates by a total charging power deviation ΔP from the maximum charging power Pₘₐₓ, which marks the right end of the bar chart 3 in FIG. 1. The maximum charging power Pₘₐₓ can be provided in a best-case scenario in which the charging power is reduced as little as possible due to the limiting influencing factors.

The limiting influencing factors can be divided into vehicle-side influencing factors, namely an actual battery temperature Tᵢₛₜ, an actual state of charge SoCᵢₛₜ, a battery health or aging Δt, a charging strategy LS, in which the battery management system BMS limits the charging power for charging strategy reasons, and a component protection Bts, as well as a vehicle-external, charging infrastructure-side influencing factor I.

A core of the invention is that in the vehicle display 1 for each of these limiting influencing factors Tᵢₛₜ, SoCᵢₛₜ, Δt, LS, Bts, I the correlating partial charging power deviations ΔP_{BT}, ΔP_{SoC}, ΔPₜ, ΔP_{LS}, ΔP_{Bts}, ΔP_{I}) are displayed in order to make the causes of the deviation of the actual charging power Pᵢₛₜ from the maximum charging power Pₘₐₓ understandable to the vehicle user. Accordingly, the bar segments 7, 9, 11, 13 shown as examples in the stacked bar chart 3 of FIG. 1 each represent the partial charging power deviations ΔP_{BT}, ΔP_{SoC}, ΔPₜ and ΔP_{I}, which correlate with the influencing factors Tᵢₛₜ, SoCᵢₛₜ, Δt and I.

In the bar chart of FIG. 1, the total of these partial charging power deviations ΔP_{BT}, ΔP_{SoC}, ΔPₜ and ΔP_{I} corresponds to the total charging power deviation ΔP. In contrast, in this exemplary embodiment, the component protection Bts and the charging strategy LS do not constitute relevant influencing factors, so that the correlating partial charging power deviations ΔP_{LS}, ΔP_{Bts} do not appear in the bar chart 3 of FIG. 1.

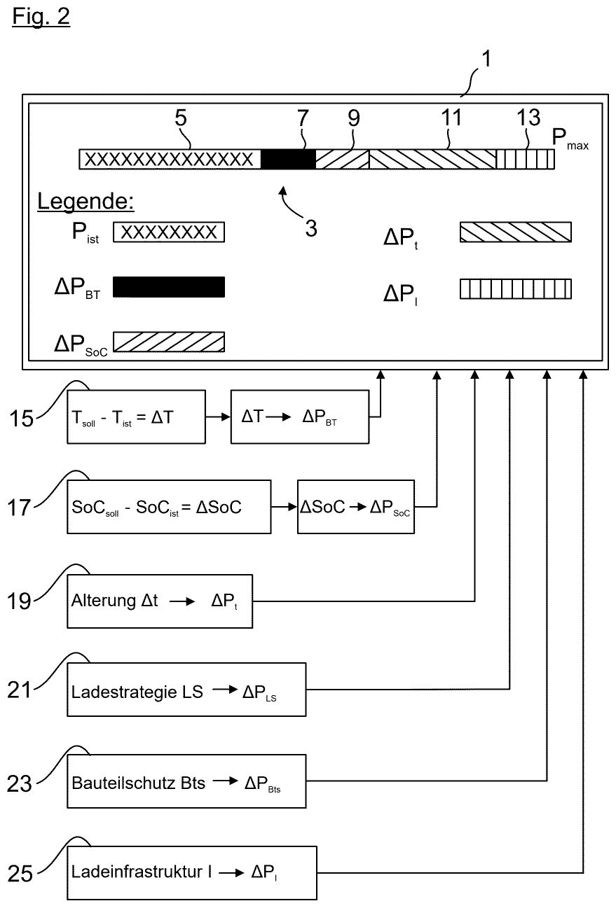

In FIG. 2, the vehicle display 1 is integrated into a roughly schematically illustrated software architecture with software evaluation units 15 to 25, which are in signal connection with the vehicle display 1. With the help of the software evaluation units 15 to 25, the partial charging power deviations ΔP_{BT}, ΔP_{SoC}, ΔPₜ, ΔP_{I}, ΔP_{LS}, ΔP_{Bts} can be determined: The evaluation unit 15 thus determines a temperature difference ΔT from the actual battery temperature Tᵢₛₜ and the battery target temperature Tₛₒₗₗ. Based on the temperature difference ΔT, the evaluation unit 15 determines the corresponding partial charging power deviation ΔP_{BT}.

Analogously, the evaluation unit 17 determines a difference ΔSoC between the actual state of charge SoCᵢₛₜ of the battery and the target state of charge of the battery, based on which difference the evaluation unit 17 determines the correlating partial charging power deviation ΔP_{SoC}.

Using the evaluation unit 19, the correlating partial charging power deviation ΔPₜ is determined based on the calendar aging Δt of the battery. With the help of the evaluation unit 21, a partial charging power deviation ΔP_{LS} is determined, which results from the charging strategy LS implemented by the battery management system BMS. With the help of the evaluation unit 23, a correlating partial charging power deviation P_{Bts} is determined based on component protection Bts (e.g. protection against overheating). With the help of the evaluation unit 25, a partial charging power deviation ΔP_{I} is determined, which correlates with the charging infrastructure, i.e. the fast charging station.

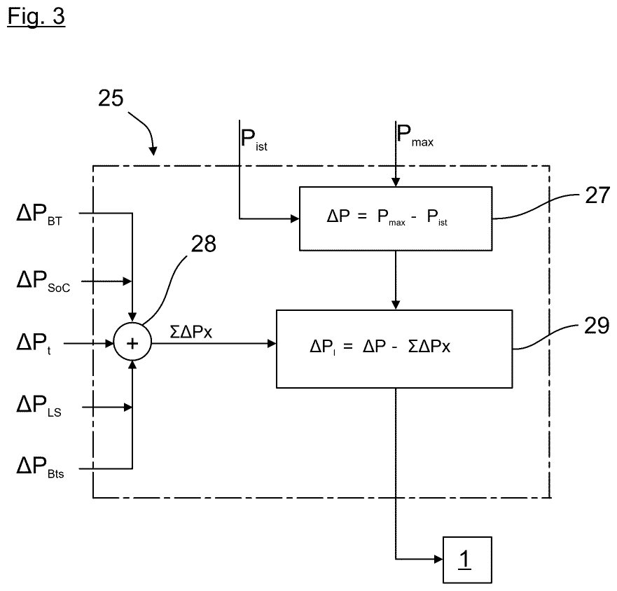

FIG. 3 shows a variant of the charging infrastructure evaluation unit 25 in isolation. Accordingly, the charging infrastructure evaluation unit 25 determines the partial charging power deviation ΔP_{I}, which correlates with the charging infrastructure, as follows: The charging infrastructure evaluation unit 25 has a calculation module 27 which calculates a total charging power deviation ΔP of the actual charging power Pᵢₛₜ from the maximum charging power Pₘₐₓ. In addition, the evaluation unit 25 has a summing element 28 with which the vehicle-side partial charging power deviations ΔP_{BT}, ΔP_{SoC}, ΔPₜ, ΔP_{LS}, ΔP_{Bts} are summed to a total value ΣΔPx. In a further calculation module 29, the total value ΣΔPx is subtracted from the total charging power deviation ΔP, resulting in the partial charging power deviation ΔP_{I}, which correlates with the charging infrastructure I.

According to the invention, the following fact is important: The high-voltage battery system and the vehicle's air conditioning system can be integrated into a common cooling system. At high outside temperatures, the cooling system therefore not only supplies cooling power to the high-voltage battery system, but also to the air conditioning system operating in cooling mode. The cooling of the vehicle interior is prioritized over the battery cooling. If the air conditioning cooling mode is activated during the fast charging process, the high-voltage battery system may no longer be supplied with sufficient cooling power. The air conditioning cooling mode therefore influences the battery temperature and consequently also the charging performance.

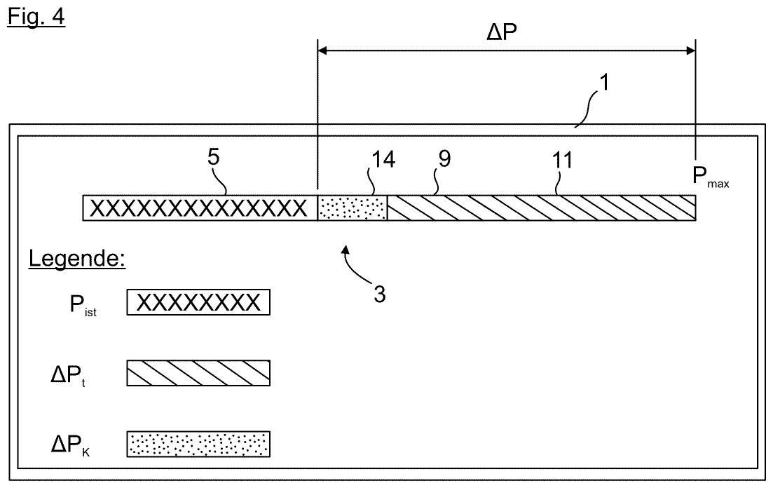

The vehicle user can track the effect of air conditioning cooling operation on the charging power during a fast charging process, for example, in the vehicle display 1 indicated in FIG. 4. Accordingly, an evaluation unit, not shown, calculates the partial charging power deviation ΔP_{K} that correlates with the air conditioning cooling operation and results from reduced battery cooling (and a concomitant increased battery temperature). Accordingly, in the stacked bar chart 3 of the vehicle display 1 there is a bar segment 14 which illustrates the partial charging power deviation ΔP_{K} due to the air conditioning cooling operation. In FIG. 4, the total charging power deviation ΔP is composed, for example, of the partial charging power deviation ΔP_{K} due to the air conditioning cooling operation (bar segment 14) and the partial charging power deviation ΔPₜ due to the battery aging Δt (bar segment 11).

### LIST OF REFERENCE NUMERALS

1 display means or vehicle display
3 stacked bar chart
5 to 14 bar segments
15 to 25 evaluation units
27, 29 calculation modules
28 summing component
Pᵢₛₜ actual charging power
Pₘₐₓ maximum charging power
Tᵢₛₜ actual battery temperature
Tₛₒₗₗ battery target temperature
ΔT temperature difference
SoCᵢₛₜ actual charging state
SoCₛₒₗₗ charging state
ΔSoC difference
Δt battery aging
LS charging strategy
Bts component protection
I charging infrastructure
BMS battery management system
ΔP_{BT} partial charging power deviation
ΔP_{SoC} partial charging power deviation
ΔPₜ partial charging power deviation
ΔP_{LS} partial charging power deviation
ΔP_{Bts} partial charging power deviation
ΔP_{I} partial charging power deviation
ΔP_{K} Partial charging power deviation
ΔP total charging power deviation
ΣΔPx sum value

1. A battery-powered vehicle with a display which, during a charging process, in particular a fast charging process, displays a maximum charging capacity which indicates the maximum charging power with which the charging process can be carried out in the best possible case, and displays a current charging capacity which indicates the actual charging power with which the charging process is currently carried out, wherein, due to limiting influencing factors, a deviation of the actual charging power from the maximum charging power may occur,
wherein the display displays a correlating partial charging power deviation for each of the limiting influencing factors in order to make the cause of the deviation of the actual charging power from the maximum charging power understandable to the vehicle user.

2. The battery-powered vehicle according to claim 1, wherein the limiting influencing factors can be divided into vehicle-side influencing factors, namely battery temperature, charging state, battery aging, charging strategy, in which the battery management system limits the charging power for charging strategy reasons, and component protection, as well as an external influencing factor related to the charging infrastructure.

3. The battery-powered vehicle according to claim 2, wherein the vehicle has an evaluation unit for each of the influencing factors which, on the basis of the respective influencing factor, determines the correlating partial charging power deviation and transmits a corresponding signal to the display.

4. The battery-powered vehicle according to claim 3, wherein to determine the partial charging power deviation correlating with the charging infrastructure-side influencing factor, the charging infrastructure evaluation unit has the following calculation modules:
a calculation module which calculates a total charging power deviation by subtracting the actual charging power from the maximum charging power; and
a calculation module which calculates the partial charging power deviation that correlates with the charging infrastructure-side influencing factor by subtracting the partial charging power deviations that correlate with the vehicle-side influencing factors from the total charging power deviation.

5. The battery-powered vehicle according to claim 3, wherein the partial charging power deviation correlating with the charging infrastructure-side influencing factor is determined by subtraction, in which a charging power that can be provided by the charging infrastructure is subtracted from a vehicle-side charging power requirement.

6. The battery-powered vehicle according to claim 1, wherein the partial charging power deviation correlating with the respective limiting influencing factor is only displayed in the display if it is greater than a predefined minimum value, approximately 10 kW.

7. The battery-powered vehicle according to claim 1, wherein in the event that the sum of all partial charging power deviations correlating with the influencing factors is smaller than a predefined minimum value, this sum is displayed in the display as the partial charging power deviation correlating with the charging strategy of the battery management system.

8. A method for operating a battery-powered vehicle according to claim 1.

9. The battery-powered vehicle according to claim 2, wherein the partial charging power deviation correlating with the respective limiting influencing factor is only displayed in the display if it is greater than a predefined minimum value, approximately 10 kW.

10. The battery-powered vehicle according to claim 3, wherein the partial charging power deviation correlating with the respective limiting influencing factor is only displayed in the display if it is greater than a predefined minimum value, approximately 10 kW.

11. The battery-powered vehicle according to claim 4, wherein the partial charging power deviation correlating with the respective limiting influencing factor is only displayed in the display if it is greater than a predefined minimum value, approximately 10 kW.

12. The battery-powered vehicle according to claim 5, wherein the partial charging power deviation correlating with the respective limiting influencing factor is only displayed in the display if it is greater than a predefined minimum value, approximately 10 kW.

13. The battery-powered vehicle according to claim 2, wherein in the event that the sum of all partial charging power deviations correlating with the influencing factors is smaller than a predefined minimum value, this sum is displayed in the display as the partial charging power deviation correlating with the charging strategy of the battery management system.

14. The battery-powered vehicle according to claim 3, wherein in the event that the sum of all partial charging power deviations correlating with the influencing factors is smaller than a predefined minimum value, this sum is displayed in the display as the partial charging power deviation correlating with the charging strategy of the battery management system.

15. The battery-powered vehicle according to claim 4, wherein in the event that the sum of all partial charging power deviations correlating with the influencing factors is smaller than a predefined minimum value, this sum is displayed in the display as the partial charging power deviation correlating with the charging strategy of the battery management system.

16. The battery-powered vehicle according to claim 5, wherein in the event that the sum of all partial charging power deviations correlating with the influencing factors is smaller than a predefined minimum value, this sum is displayed in the display as the partial charging power deviation correlating with the charging strategy of the battery management system.

17. The battery-powered vehicle according to claim 6, wherein in the event that the sum of all partial charging power deviations correlating with the influencing factors is smaller than a predefined minimum value, this sum is displayed in the display as the partial charging power deviation correlating with the charging strategy of the battery management system.
